(19) United States
(12) Patent Application Publication
(10) Pub. No.: US 2006/0091994 A1
(43) Pub. Date: May 4, 2006

(54) Independently housed trim resistor and a method for fabricating same

(76) Inventor: Charles Scott Nelson, Fenton, MI (US)

Correspondence Address: DELPHI TECHNOLOGIES, INC., M/C 480-410-202, PO BOX 5052, TROY, MI, 48007, US

(21) Appl. No.: 11/297,903

(22) Filed: Dec. 9, 2005

Related U.S. Application Data
(63) Continuation-in-part of application No. 10/472,409, filed on Sep. 17, 2003.
(60) Provisional application No. 60/277,037, filed on Mar. 19, 2001.

(51) Int. Cl. H01C 10/00

(52) U.S. Cl. 338/195

(57) ABSTRACT

A resistor assembly, comprising: a housing body having a recess defined by a peripheral edge; a pair of channels disposed in the peripheral edge, the pair of channels extending from the recess and through the peripheral edge; a trim resistor element disposed in the recess, the trim resistor element comprising a nonconductive support surface, a pair of conductive pads disposed on the nonconductive support surface, the pair of conductive pads being disposed in a spaced relationship on the nonconductive support surface, and a trimable resistive film disposed on the nonconductive support surface, the trimable resistive film being in electrical communication with each of the pair of conductive pads at separate locations to provide a conductive path between the pair of conductive pads through the trimable resistive film; a pair of lead wires, each lead wire comprising an electrically insulative sheath disposed about a metallic wire, each lead wire further comprising a terminal section formed of an exposed metallic wire stripped of the electrically insulative sheath, wherein each wire is arranged with the housing body such that the insulative sheath is received in one of the pair of channels and the terminal section extends into the recess to make electrical contact with a respective one of the pair of conductive pads; a housing top fixed to the housing body, the housing top having a first top portion and a second top portion, the first top portion overlying a portion of the pair of lead wires and clamping the electrically insulated sheath within a respective one of the pair of channels and the terminal section against a respective one of the pair of conductive pads, the housing top further comprising a second top portion, the second top portion having an opening defined by a perimeter, the opening overlying and exposing the trimable resistive element and the perimeter overlying a portion of the trim resistive element to retain the resistive element within the recess.

### CROSS REFERENCE TO RELATED APPLICATIONS

This application is a continuation-in-part (CIP) of U.S. patent application Ser. No. 10/472,409, attorney docket no. DP-304209 filed Sep. 17, 2003, which is a National Stage Entry of PCT/US02/07449, which claims priority to U.S. Provisional Application 60/277,037, filed Mar. 19, 2001 the contents each of which are incorporated herein by reference thereto.

### BACKGROUND

Some exhaust sensors need a compensation resistor to tell the electronics how to compensate for part-to-part variability in the sensor itself. There are two ways to do this, first using a discrete fixed resistor. A fixed value resistor requires a very large collection of resistors in which the manufacturer must pick a resistor that is closest in value to the required resistance. This will almost never allow for a perfect match and requires many different part numbers. The second way of compensation is to use a trim resistor, which requires a laser to burn a resistive surface until the exact resistance is achieved. This requires only one part number and perfectly matches the desired resistance. The current method of attaching trim resistors to sensors is to integrate the trim resistor into the off end connector. While this is compact, it is not flexible to customers needs if they wish to use a different connector.

### SUMMARY OF THE INVENTION

A resistor assembly, comprising: a housing body having a recess defined by a peripheral edge; a pair of channels disposed in the peripheral edge, the pair of channels extending from the recess and through the peripheral edge; a trim resistor element disposed in the recess, the trim resistor element comprising a nonconductive support surface, a pair of conductive pads disposed on the nonconductive support surface, the pair of conductive pads being disposed in a spaced relationship on the nonconductive support surface, and a trimable resistive film disposed on the nonconductive support surface, the trimable resistive film being in electrical communication with each of the pair of conductive pads at separate locations to provide a conductive path between the pair of conductive pads through the trimable resistive film; a pair of lead wires, each lead wire comprising an electrically insulative sheath disposed about a metallic wire, each lead wire further comprising a terminal section formed of an exposed metallic wire stripped of the electrically insulative sheath, wherein each wire is arranged with the housing body such that the insulative sheath is received in one of the pair of channels and the terminal section extends into the recess to make electrical contact with a respective one of the pair of conductive pads; a housing top fixed to the housing body, the housing top having a first top portion and a second top portion, the first top portion overlying a portion of the pair of lead wires and clamping the electrically insulated sheath within a respective one of the pair of channels and the terminal section against a respective one of the pair of conductive pads, the housing top further comprising a second top portion, the second top portion having an opening defined by a perimeter, the opening overlying and exposing the trimable resistive element and the perimeter overlying a portion of the trim resistive element to retain the resistive element within the recess.

### BRIEF DESCRIPTION OF THE DRAWINGS

The present invention will now be described, by way of an example, with references to the accompanying drawings, wherein like elements are numbered alike in the several figures in which:

FIG. 1 shows an exploded perspective view of an independently housed trim resistor in accordance with an exemplary embodiment;

FIG. 2 shows a perspective view of an independently housed trim resistor in accordance with an exemplary embodiment;

FIG. 2A is a view along lines 2A-2A of FIG. 2;

FIG. 2B is a view along lines 2B-2B of FIG. 2;

FIG. 3 shows a top down view of a trim resistor in accordance with an exemplary embodiment;

FIG. 4 shows a block diagram describing a method for fabricating an independently housed trim resistor in accordance with an exemplary embodiment;

FIG. 5 shows a cross sectional view of an example of an independently housed trim resistor disposed within a sensor wire sheath in accordance with an exemplary embodiment;

FIG. 6 shows an example of a final sensor assembly which employs an independently housed trim resistor in accordance with an exemplary embodiment; and

FIG. 7 is another perspective view of trim resistor assembly constructed in accordance with exemplary embodiments of the present invention.

### DETAILED DESCRIPTION OF EXEMPLARY EMBODIMENTS

Referring now to the figures, an independently housed trim resistor 1 is provided that advantageously allows for a wide range of devices to employ a trim resistor by providing a novel trim resistor design that can be used with a variety of circuit connectors inexpensively and effectively.

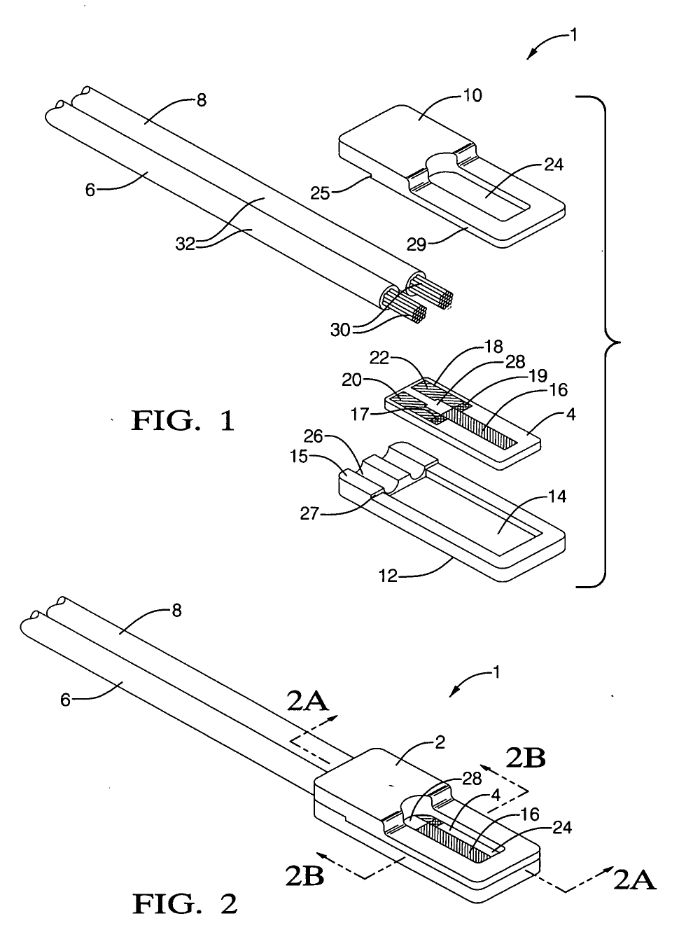

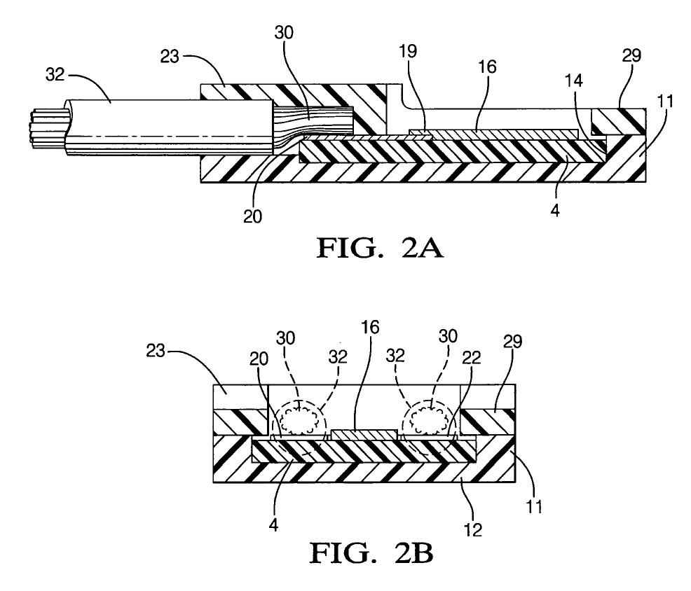

Referring to the drawings, FIG. 1 and FIG. 2 show independently housed trim resistor 1 having a resistor housing 2, a trim resistor element 4 and a plurality of lead wires including a first lead wire 6 and a second lead wire 8 in accordance with an exemplary embodiment. In one embodiment, resistor housing 2 preferably includes a housing top 10 and a housing body 12, wherein housing body 12 defines a resistor cavity or receiving area 14 for receiving and containing trim resistor element 4 therein. A portion of a periphery of the resistor cavity is defined by a peripheral wall 11 and an end wall portion 15 of the housing body as illustrated, the housing body comprises a first body portion and a second body portion, the first body portion including wall portion 15 and the second body portion including peripheral wall 11.

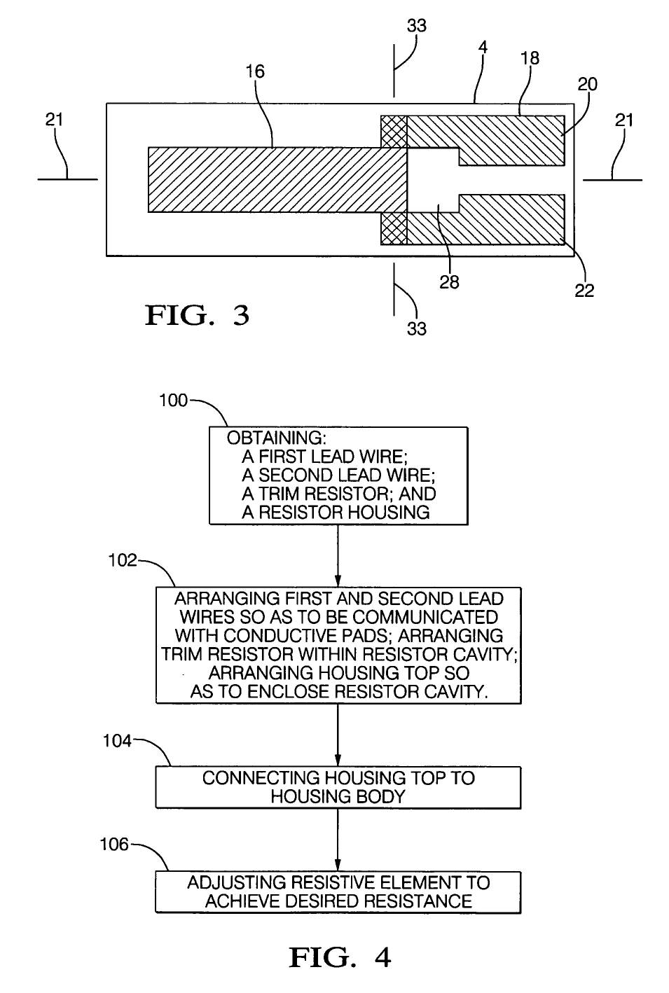

Referring to FIG. 3, a trim resistor element 4 is shown in accordance with an exemplary embodiment. Trim resistor element 4 preferably includes a trimable resistive element or trimable resistive film 16 comprising an electrically conductive material and a plurality of conductive pads 18 for example, a first pad 20 and a second pad 22, which are shown in the Figures, wherein the first pad and the second pad are in electrical communication with resistive element 16 by for example overlapping a portion of the conductive material of the conductive pads with separate portions of the resistive element to provide a pair of overlapping areas 17 and 19. In accordance with an exemplary embodiment, the resistive element provides an electrical resistance between first pad 20 and second pad 22.

As illustrated, the resistor element has a longitudinal axis 21 parallel to the channels of the housing body, and a lateral axis 33 perpendicular to the longitudinal axis. In accordance with an exemplary embodiment, the conductive pads extend from the lateral axis in a first direction towards the pair of channels and the trimable resistive film extends from the lateral axis in a second direction away from the channel, wherein the pair of conductive pads each contact the trimable resistive film at the lateral axis. In accordance with an exemplary embodiment and as discussed herein the pair of conductive pads each underlie or overlie the trimable resistive film at the lateral axis. As illustrated, the conductive pads are positioned on the non-conductive substrate in a parallel spaced relationship with respect to each other.

In accordance with an exemplary embodiment, trimable resistive element 16, first pad 20 and second pad 22 are preferably disposed so as to create an open area 28 adjacent to resistive element 16. In addition, housing top 10 preferably includes a trim opening 24 disposed so as to allow communication with resistive element 16 and open area 28. Moreover, resistor housing 2 preferably includes a pair of openings or channels 26 disposed in end wall portion 15 and depending on the configuration of the housing, a pair of complimentary channels are disposed in a lower surface of housing top 10.

Channels 26 are configured to provide a path from an outer periphery of the housing body and the housing top into resistor cavity 14 such that the lead wires can be terminated with plurality of conductive pads 18. In accordance with an exemplary embodiment the channels are disposed in a parallel, spaced relationship wherein a first one of the conductive pads is disposed proximate to one of the pair of channels and a second one of the conductive pads is disposed proximate to the other one of the pair of channels.

In addition, a portion or first top portion 23 of housing top 10 is configured to secure the lead wires between housing top 10 and housing body 12 as well as providing a sufficient force or compressive force to the wire so that an electrical termination of the conductive cores of the lead wires is provided to the conductive pads. As illustrated, portion 23 is configured to have a step or feature 25 configured to cooperate with a complimentary step or feature 27 lower portion 12 wherein a compressive force is applied by a lower portion of upper housing portion 10 to un-insulated portions of the lead wires to ensure electrical contact is made once upper portion 10 is secured to lower portion 12. As illustrated, feature or step 27 is created by wall portion 15 having a height greater than wall portion 11. Of course, other configurations of housing top and housing body capable of providing the necessary compressive force (e.g., lead wire termination) are contemplated to be within the scope of exemplary embodiments of the present invention.

It is also understood, that in an alternative exemplary embodiment a temporary initial electrical connection may be made by a terminal contacting the conductive pad or a tack weld or spot weld, which is permanently secured thereto by the force of the housing top.

First lead wire 6 and second lead wire 8 preferably include a conductive core 30 and a protective sheath 32 encasing conductive core 30. In accordance with an exemplary embodiment, first lead wire 6 is preferably disposed such that conductive core 30 is in electrical communication with first pad 20 and second lead wire 8 is preferably disposed such that conductive core 30 is in electrical communication with second pad 22.

In accordance with an exemplary embodiment, first lead wire 6 and second lead wire 8 may be any wire suitable to the desired end purpose.

In accordance with an exemplary embodiment, housing top 10 is preferably non-movably associated with housing body 12 so as to secure the trim element in the resistor cavity or receiving area 14.

In addition, trimable resistive element 16 is applied to provide a layer of trimable resistive film that is preferably removably associated with trim resistor element 4.

Referring to the figures, a method for fabricating an independently housed trim resistor 1 as described hereinabove is illustrated and discussed. In accordance with an exemplary embodiment, a first lead wire 6, a second lead wire 8, a trim resistor element 4 having a trimable resistive element 16 and a plurality of conductive pads 18 disposed thereon and a resistor housing 2 having a housing top 10 and a housing body 12 are obtained as shown in step 100. In accordance with an exemplary embodiment, resistor housing 2 preferably includes a pair of openings or channel openings 26 disposed so as to allow the lead wires to be in electrical communication with the conductive pads 18. In addition, housing top 10 preferably includes a trim opening 24, which allows direct contact with the resistive element when the trim element is retained within the resistor cavity by portion 23 and peripheral portion or second top portion 29 of housing top 10.

First lead wire 6 and second lead wire 8 are then arranged so as to be communicated with conductive pads 20 and 22 via a respective opening or channel 26 extending into resistor cavity 14, wherein first lead wire 6 is communicated with first pad 20 and second lead wire 8 is communicated with second pad 22, as shown in step 102. Trim resistor element 4 is then arranged so as to be disposed within resistor cavity 14 such that resistive element 16 is directed away from housing body 12 and housing top 10 is then arranged to cover trim a portion of resistor element 4 and enclose resistor cavity 14, also as shown in step 102.

In accordance with an exemplary embodiment, housing top 10 is preferably disposed relative to trim resistor element 4 and housing body 12 so as to allow communication with resistive element 16 via trim opening 24. Also, housing top 10 is preferably disposed relative to housing body 12 so as to cause first lead wire 6 and second lead wire 8 to be compressingly and non-movably associated with plurality of conductive pads 18. Moreover, housing top 10 is configured and preferably arranged relative to housing body 12 so as to non-movably contain trim resistor element 4 within resistor cavity 14. In accordance with an exemplary embodiment a depth of the resistor cavity and a width or height of the trim resistor element positions a top surface of the trim element proximate to a top surface of peripheral wall 11. In addition, a perimeter portion 29 of the housing top is configured to define opening 24, while also providing a means for securing the trim resistor therein when housing top is secured to housing body 12. In other words, perimeter portion 29 has a larger width than peripheral wall or perimeter portion 11 of housing body 12 that defines resistor cavity 14, such that a portion of perimeter portion 29 will make contact with a portion of the resistor element when it is disposed in the resistor cavity.

Once all of the components of independently housed trim resistor 1 have been arranged as shown in step 102, housing top 10 is then connected to housing body 12 as shown in step 104. In accordance with an exemplary embodiment, housing top 10 and housing body 12 are formed out of non-conductive plastic and housing top 10 is preferably ultrasonically welded to housing body 12 so as to create a seal between housing top 10 and housing body 12. One non-limiting example of the plastic material for the housing top and housing body is Valox plastic.

In addition, housing top 10 is preferably ultrasonically welded to housing body 12 so as to create a seal between first lead wire 6 and resistor housing 2 and between second lead wire 8 and resistor housing 2. In accordance with an exemplary embodiment, the plastic housing itself seals around the insulation of the wires, a portion of the trim element, and the plastic of the complimentary housing portions to create a hermetic seal about the un-insulated wires and the conductive pads they make contact with. As used herein and in an exemplary embodiment, hermetic seal is defined as fluid leakage being <0.5 cc/min at an external pressure of 7-7.5 psi. Of course, ranges above and below the aforementioned ranges are contemplated to within the scope of exemplary embodiments of the present invention.

In another exemplary embodiment and after the wires are sealed between housing top 10 and housing body 12 (e.g., within channels 26) and the un-insulated portions are sealed in electrical contact with conductive pads 20 and 22 (e.g., pressure exerted from housing top portion 23) the hermetic seal about the lead wires (conductive and non-conductive portions) is further provided by the sealant disposed in cavity 24, which provides a seal between the interior perimeter of opening 24 and the resistor element making contact with the interior perimeter.

Although housing top 10 is preferably connected to housing body 12 via ultrasonic welding, housing top 10 may be connected to housing body 12 using any method suitable to the desired end purpose (e.g., securing the lead wires therebetween and in one exemplary embodiment hermetically sealing the wires therein). In accordance with an exemplary embodiment the connection process will provide a high normal force crimp on the bare wire of first lead wire 6 and second lead wire 8 so that electrical connection is made with the conductive pads of the trim resistor element 4.

Once housing top 10 has been connected to housing body 12 as shown in step 104, resistive element 16 is adjusted (e.g., removing portions of the resistive element 16 so as to change the resistance between first pad 20 and second pad 22 by for example, extending the length of the conductive path of the resistive element between pad 20 and pad 22 as well as reducing the width of the conductive path between pad 20 and 22) so as to achieve a desired resistance between first pad 20 and second pad 22, as shown in step 106. In accordance with an exemplary embodiment, resistive element 16 is preferably adjusted via laser trimming. This is preferably done by communicating a laser beam with a predetermined starting position within open area 28 of trim resistor element 4 via trim opening 24. In accordance with an exemplary embodiment, the laser would preferably find its proper starting location by finding the predetermined starting position disposed somewhere within open area 28 of trim resistor element 4. However, the laser may find its proper starting location by locating two edges that are ninety degrees apart from each other or by finding the top and either the right or left edge of resistive element 16. In accordance with an exemplary embodiment, the laser will make a series of passes over the trimable resistive element by for example, in an “I”, “L”, “J” or hook patterns, which can be inverted, wherein the desired amount of the resistive film of the resistive element is removed to provide an electrical conduit or path between the conductive pads, which has a known resistive value. Of course, any configuration is contemplated (e.g., zigzag) as long as there is a conductive path between the conductive pads.

Once the laser has been communicated with the predetermined starting position, the laser beam then removes a portion of resistive element 16 by cutting into resistive element 16 until a desired resistance is achieved between first pad 20 and second pad 22. In accordance with an exemplary embodiment, additional laser cuts may be used to further refine the resistance by for example, removing portions of the resistive element.

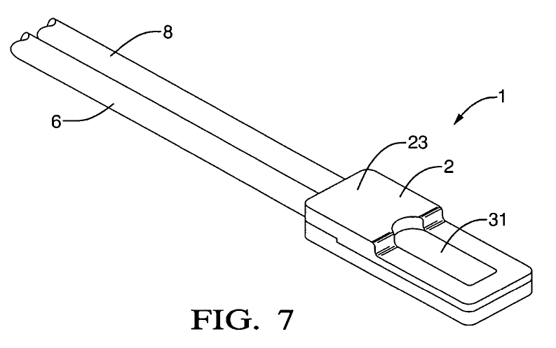

Once the desired resistance has been achieved, and since trim opening 24 is located above resistive element 16, an adhesive coating or sealant 31 may be applied to housing top 10 so to create a protective seal to the area within trim opening 24. In accordance with an exemplary embodiment adhesive coating or sealant 31 may be any adhesive coating having non-conductive properties capable of bonding to resistor housing 2 so as to form a watertight seal, such as an acrylic encapsulate. FIG. 7 illustrates sealant 31 disposed in opening 24 after the desired resistance is achieved. Sealant may be clear or opaque or any combination thereof.

FIG. 2A illustrates a view along lines 2A-2A of FIG. 2. As illustrated, housing top 10 is secured to housing bottom 12 wherein trim element 4 is retained in cavity 14 by a peripheral wall portion 29, which is wider than peripheral wall portion 11 and upper housing portion 23, which overlays a portion of the pair of lead wires clamping the electrically insulated sheath within a respective one of the pair of channels and the terminal section against a respective one of the pair of conductive pads.

In addition, opening 24 overlays and exposes the trimable resistive element disposed on a surface of the non-conductive substrate of the trim element, allowing for direct contact and removal of a portion of the trimable resistive element as well as applying a sealant thereto after a portion of the trimable resistive element has been removed to provide the desired resistance.

FIG. 2B illustrates a view along lines 2B-2B of FIG. 2. As illustrated, housing top 10 is secured to housing bottom 12 wherein trim element 4 is retained in cavity 14 by a peripheral wall portion 29, which is wider than peripheral wall portion 11 and upper housing portion 23, is configured to overlay and seal a portion of the pair of lead wires within a respective one of the pair of channels as well as provide a direct contact force to the terminal section such that an electrical contact is made against a respective one of the pair of conductive pads.

In accordance with exemplary embodiments, trim opening 24 and trimable resistive element 16, conductive pads 20 and 22 are configured such that only a portion of the trimable resistive element is accessible for trimming via opening 24 or alternatively a portion of conductive pads 20 and 22 are also accessible via opening 24 and thereafter are sealed by sealant 31 or alternatively no portion of the conductive pads are accessible and all of the trimable resistive element is accessible or any combinations of the foregoing are contemplated wherein desired resistances are achieved by removing a portion of the trimable resistive element.

In accordance with an exemplary embodiment, the resistance of resistive element 16 may be measured via a passive trim approach or via an active trim approach. One type of passive trim measurement approach, which may or may not be performed during the lasing process, measures the resistance of resistive element 16 by probing either first pad 20 and second pad 22 and/or first lead wire 6 and second lead wire 8, using any resistance measurement device suitable to the desired end purpose. If the resistance is being measured during the lasing process, the laser will terminate lasing once a desired resistance is achieved. If the resistance is not being measured during the lasing process, the resistance will be measured following a laser cut. If the resistance is not as desired, the lasing processes will be repeated until a desired resistance is achieved. Another type of passive trim measurement approach would be to calculate, using the property characteristics of resistive element 16, how much of the resistive element 16 must be removed in order to achieve a desired resistance. Once this is calculated, the laser may be precisely controlled to remove the calculated quantity.

In accordance with an exemplary embodiment, under an active trim measurement approach, which also may or may not be performed during the lasing process, independently housed trim resistor 1 is connected to a desired device, such as a sensor. A known condition is applied to the input of the device and the output of the device is monitored. The resistance of resistive element 16 is then adjusted, as discussed hereinabove, until a desired output of the device is achieved.

In accordance with an exemplary embodiment, although resistance of resistive element 16 is explained hereinabove as being adjusted using a laser, the resistance of resistive element 16 may be adjusted using any suitable adjustment method or device, such as sandblasting, high pressure air or water cutting. In addition, the laser used to adjust resistive element 16 may be any laser that abates material.

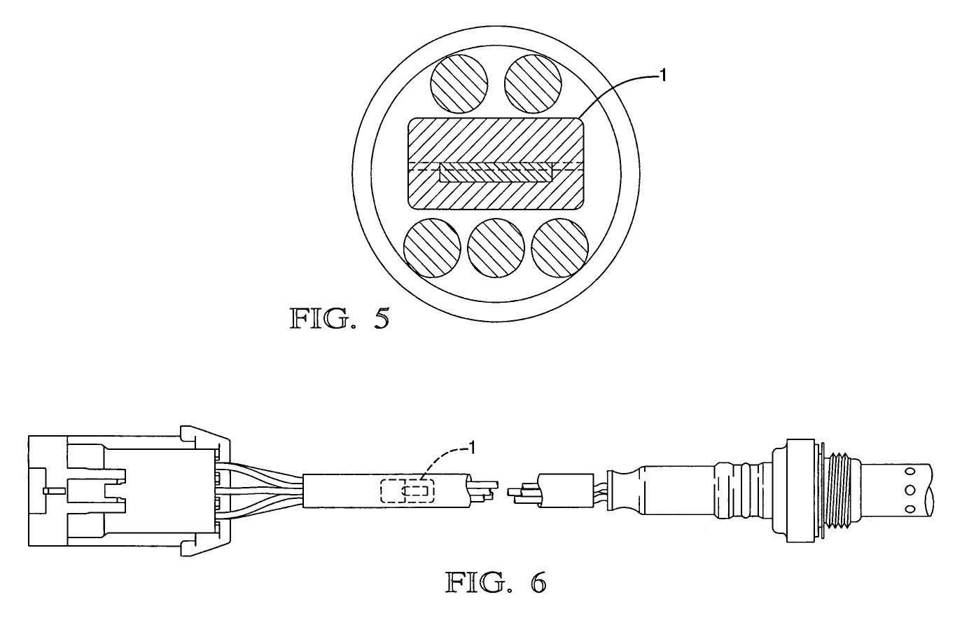

In accordance with an exemplary embodiment, wire terminations may be applied to first lead wire 6 and second lead wire 8 so as to allow independently housed trim resistor 1 to be communicated with external devices, such as wide range sensors. Independently housed trim resistor 1 may then be secured using any suitable retention method, such as tape or inserting independently housed trim resistor 1 into a wire protection sheath along with other device wires as shown in FIG. 5 and FIG. 6.

In accordance with an exemplary embodiment, trim resistor element 4 preferably comprises a ceramic substrate of non-conductive materials. However, trim resistor element 4 may be constructed of any material suitable to the desired end purpose.

In accordance with an exemplary embodiment, resistive element 16 is preferably constructed of printed resistor ink, such as ruthenium oxide, which is applied via silk screening, printing or any other suitable process to provide the desired amount of trimable resistive film on the nonconductive surface of the resistor element. However, resistive element 16 may be constructed of any resistive material suitable to the desired end purpose.

In accordance with an exemplary embodiment, first pad 20 and second pad 22 are preferably constructed using a conductive ink constructed of a conductive material, such as palladium. However, first pad 20 and second pad 22 may be constructed of any conductive material that resists oxidation and that is suitable to the desired end purpose.

As discussed herein, one non-limiting example of the trimable resistive film is a ruthenium oxide disposed on a non-conductive surface of the trim resistor element by for example, in an ink form, wherein the trim resistor element comprises a ceramic substrate such as AlO₂ and the trimable resistive film is in electrical communication with a plurality of conductive pads disposed on the non-conductive surface of the ceramic substrate. One non-limiting example of the conductive pads are areas of conductive ink such as palladium, which are configured to overlap a portion of the conductive ink comprising the trimable resistive film providing overlapping areas, which comprise electrical contact points between the conductive pads and the trimable resistive film.

In addition, the periphery of trim opening 24 will provide a means for retaining the sealing material therein until it has cured (e.g., a liquid sealing material is disposed into trim opening 24 making direct contact with the trimable resistive film).

As illustrated, electrical communication is provided to at least two separate areas of the conductive ink of the trimable resistive film. The electrical communication in one exemplary embodiment being at the locations where the conductive ink of the resistive film overlaps with the conductive ink of the contact pads. Of course, and in accordance with exemplary embodiment of the present invention, numerous other configurations for providing electrical communication with the resistive film are contemplated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A resistor assembly, comprising:
a housing body having a recess defined by a peripheral edge;
a pair of channels disposed in the peripheral edge, the pair of channels extending from the recess and through the peripheral edge;
a trim resistor element disposed in the recess, the trim resistor element comprising a nonconductive support surface, a pair of conductive pads disposed on the nonconductive support surface, the pair of conductive pads being disposed in a spaced relationship on the nonconductive support surface, and a trimable resistive film disposed on the nonconductive support surface, the trimable resistive film being in electrical communication with each of the pair of conductive pads at separate locations to provide a conductive path between the pair of conductive pads through the trimable resistive film;
a pair of lead wires, each lead wire comprising an electrically insulative sheath disposed about a metallic wire, each lead wire further comprising a terminal section formed of an exposed metallic wire stripped of the electrically insulative sheath, wherein each wire is arranged with the housing body such that the insulative sheath is received in one of the pair of channels and the terminal section extends into the recess to make electrical contact with a respective one of the pair of conductive pads;
a housing top fixed to the housing body, the housing top having a first top portion and a second top portion, the first top portion overlying a portion of the pair of lead wires and clamping the electrically insulated sheath within a respective one of the pair of channels and the terminal section against a respective one of the pair of conductive pads, the housing top further comprising a second top portion, the second top portion having an opening defined by a perimeter, the opening overlying and exposing the trimable resistive element and the perimeter overlying a portion of the trim resistive element to retain the resistive element within the recess.

2. The resistor assembly as in claim 1, wherein the pair of channels are disposed in a parallel, spaced relationship, and wherein a first one of the pair of conductive pads is disposed proximate to one of the pair of channels and a second one of the pair of conductive pads is disposed proximate to the other one of the pair of channels and the resistor housing is constructed from a non-conductive plastic material.

3. The resistor assembly as in claim 1, wherein the resistor element has a longitudinal axis parallel to the pair of channels of the housing body, and wherein the nonconductive support surface includes a lateral axis perpendicular to the longitudinal axis, and wherein the conductive pads extend from the lateral axis in a first direction towards the pair of channels and the trimable resistive film extends from the lateral axis in a second direction away from the pair of channels.

4. The resistor assembly as in claim 3, wherein the pair of conductive pads each contact the trimable resistive film at the lateral axis.

5. The resistor assembly as in claim 4, wherein the pair of conductive pads each overlie or underlie separate portions of the trimable resistive film at the lateral axis.

6. The resistor assembly as in claim 1, wherein the non-conductive support surface is constructed of a ceramic substrate and the pair of channels are disposed in a parallel, spaced relationship, and wherein a first one of the pair of conductive pads is disposed proximate to one of the pair of channels and a second one of the pair of conductive pads is disposed proximate to the other one of the pair of conductive pads and the housing top and the housing body are constructed out of plastic and the housing top is sonically welded to the housing body wherein the plastic of the housing top and the housing body seals around the insulation of the wires to create a hermetic seal and the trimable resistive film is a conductive ink disposed on the nonconductive support surface and a portion of the ink is removed to provide a desired resistance on a conductive path between the pair of conductive pads, the conductive path being defined by an un-removed portion of ink electrically connecting the conductive pads, wherein a protective coating is applied into the trim opening after the desired trim resistance has been achieved.

7. The resistive assembly as in claim 1, wherein the housing body further comprises a first body portion and a second body portion, the second body portion defining the recess and comprising a first portion of the peripheral edge, the first body portion comprising a second portion of the peripheral edge, wherein the pair of channels are disposed in the second portion of the peripheral edge and the second portion of the peripheral edge has a height and width greater than a height and width of the first portion of the peripheral edge.

8. The resistive assembly as in claim 7, further comprising a protective coating applied into the opening after a desired trim resistance has been achieved by removing a portion of the trimable resistive film and wherein a height of the trim resistor element is less than or equal to the height of the first portion of the peripheral edge.

9. The resistive assembly as in claim 1, further comprising a wire protection sheath disposed about the housing body and the housing top.

10. The resistor assembly as in claim 1, wherein the housing top and the housing body are constructed out of plastic and the housing top is sonically welded to the housing body wherein the plastic of the housing top and the housing body seals around the insulation of the wires to create a hermetic seal.
